(19) United States
(12) Patent Application Publication
(10) Pub. No.: US 2021/0239275 A1
(43) Pub. Date: Aug. 5, 2021

(54) MONITORING STORAGE CONDITIONS IN CRYOGENIC STORAGE TANKS

(71) Applicant: THE TRUSTEES OF COLUMBIA UNIVERSITY IN THE CITY OF NEW YORK, New York, NY (US)

(72) Inventor: S. Zev Williams, New York, NY (US)

(73) Assignee: THE TRUSTEES OF COLUMBIA UNIVERSITY IN THE CITY OF NEW YORK, New York, NY (US)

(21) Appl. No.: 17/239,861

(22) Filed: Apr. 26, 2021

Related U.S. Application Data
(63) Continuation of application No. PCT/US2019/058257, filed on Oct. 28, 2019.
(60) Provisional application No. 62/752,099, filed on Oct. 29, 2018.
(60) Provisional application No. 62/751,051, filed on Oct. 26, 2018.

(51) Int. Cl. F17C 13/02

(52) U.S. Cl. CPC F17C 13/026; F17C 2223/0161; F17C 2250/0421; F17C 2250/032; F17C 2201/0104; F17C 2250/036; F17C 2250/0439

(57) ABSTRACT

According to one embodiment, there is provided a storage condition monitoring device for monitoring a storage condition in a cryogenic storage container. The storage condition monitoring device includes an input/output (I/O) circuitry, a memory circuitry, a processor circuitry, a user interface and a storage condition monitor circuitry. The I/O circuitry is configured to receive a first total weight from a weight sensor. The first total weight includes a weight of the cryogenic storage container and a first weight of a content contained in the cryogenic storage container. The cryogenic storage container is configured to contain a coolant and a biological material storage subcontainer. The user interface is configured to provide at least one of a visual indicator, an audible indicator and/or an electronic indicator. The storage condition monitor circuitry is configured to determine a current storage condition of the cryogenic storage container based, at least in part, on the first total weight. The storage condition monitor circuitry is further configured to select a storage condition status indicator based, at least in part, on the current storage condition and to provide the storage condition status indicator to one or more of the user interface, a worker device and a supervisor device.

### CROSS REFERENCE TO RELATED APPLICATION(S)

This application is a continuation of and claims the benefit of International Application No. PCT/US2019/058257, filed Oct. 28, 2019, that claims the benefit of U.S. Provisional Application No. 62/751,051, filed Oct. 26, 2018, and U.S. Provisional Application No. 62/752,099, filed Oct. 29, 2018, the entire disclosures of which are hereby incorporated by reference as if disclosed herein in their entireties.

### FIELD

The present disclosure relates to storage conditions in cryogenic storage tanks, in particular to, monitoring storage conditions in cryogenic storage tanks.

### BACKGROUND

Safeguarding cryopreserved embryos and gametes is a critical responsibility of fertility centers and tissue banks. Cryopreservation in a coolant such as liquid nitrogen (LN2) preserves the viability of biological materials by halting their molecular processes, enabling their long-term storage. Failure to maintain adequate coolant within a storage tank can result in stored samples thawing and, ultimately, in their total loss. In the case of stored embryos or eggs, such a loss can be catastrophic for affected patients, their partners and the fertility center.

Maintaining adequate coolant level is critical for maintaining the temperature inside. Many tanks are installed with a temperature alarm system for measuring temperatures and alerting users if temperature falls outside a threshold range. When the temperatures rise above a particular threshold, the alarm sounds. Temperature monitoring has some limitations. For example, temperatures start to rise after the coolant is already depleted or very nearly depleted. Thus, there is a very limited timeframe in which the coolant can be replaced before the specimens are completely lost. Since the temperature-based alarm system is configured to detect a rise in temperature, the temperature inside the tank will be above the ideal storage temperature by the time the alarm is sounded. Existing temperature monitoring equipment is typically placed within the storage tank making manipulation of samples relatively more difficult and exposing the temperature monitoring equipment to a potentially hostile environment.

### SUMMARY

In an embodiment, there is provided a storage condition monitoring device for monitoring a storage condition in a cryogenic storage container. The storage condition monitoring device includes an input/output (I/O) circuitry, a memory circuitry, a processor circuitry, a user interface and a storage condition monitor circuitry. The I/O circuitry is configured to receive a first total weight from a weight sensor. The first total weight includes a weight of the cryogenic storage container and a first weight of a content contained in the cryogenic storage container. The cryogenic storage container is configured to contain a coolant and a biological material storage subcontainer. The user interface is configured to provide at least one of a visual indicator, an audible indicator and/or an electronic indicator. The storage condition monitor circuitry is configured to determine a current storage condition of the cryogenic storage container based, at least in part, on the first total weight. The storage condition monitor circuitry is further configured to select a storage condition status indicator based, at least in part, on the current storage condition and to provide the storage condition status indicator to one or more of the user interface, a worker device and a supervisor device.

In some embodiments of the storage condition monitoring device, the determining the current storage condition includes at least one of comparing the first total weight to a weight threshold or comparing a current weight fraction to a weight fraction threshold, the current weight fraction corresponding to a ratio of the first total weight to an initial total weight.

In some embodiments of the storage condition monitoring device, the I/O circuitry is further configured to receive a second total weight from the weight sensor. The second total weight includes the weight of the cryogenic storage container and a second weight of the content contained in the cryogenic storage container. The second total weight is captured a time interval after capture of the first total weight. The storage condition monitor circuitry is configured to determine a current rate of change of weight and to compare the current rate of change of weight to a rate of change threshold.

In some embodiments of the storage condition monitoring device, the current storage condition corresponds to a severity of coolant loss from the cryogenic storage container and is related to an amount of time available for remediation.

In some embodiments of the storage condition monitoring device, the current storage condition is selected from the group including a current total weight less than or equal to a minimum weight threshold, a current total weight greater than the minimum weight threshold and less than or equal to an intermediate weight threshold, a current weight fraction less than or equal to a minimum weight fraction threshold, a current weight fraction greater than the minimum weight fraction threshold and less than or equal to an intermediate weight fraction threshold, a current rate of change of total weight greater than or equal to a minimum rate of change threshold and less than an intermediate rate of change threshold, a current rate of change of total weight greater than or equal to the intermediate rate of change threshold and less than a maximum rate of change threshold, a current rate of change of total weight greater than or equal to the maximum rate of change threshold, and/or a combination thereof.

In an embodiment, there is provided a cryogenic container storage condition monitoring system. The system includes a weight sensor, a storage condition monitoring device and a supervisor circuitry. The weight sensor is in mechanical communication with a cryogenic storage container. The cryogenic storage container is configured to contain a coolant and a biological material storage subcontainer. The weight sensor is configured to sense a first total weight of the cryogenic storage container. The first total weight includes a weight of the cryogenic storage container and a first weight of a content contained in the cryogenic storage container. The storage condition monitoring device includes an input/output (I/O) circuitry configured to receive the first total weight from the weight sensor, a memory circuitry, a processor circuitry, a user interface configured to provide at least one of a visual indicator, an audible indicator and/or an electronic indicator, and a storage condition monitor circuitry. The supervisor circuitry is coupled to the storage condition monitoring device. The storage condition monitor circuitry is configured to determine a current storage condition of the cryogenic storage container based, at least in part, on the first total weight. The storage condition monitor circuitry is further configured to select a storage condition status indicator based, at least in part, on the current storage condition and to provide the storage condition status indicator to one or more of the user interface, a worker device and the supervisor device.

In some embodiments of the system, the determining the current storage condition includes at least one of comparing the first total weight to a weight threshold or comparing a current weight fraction to a weight fraction threshold, the current weight fraction corresponding to a ratio of the first total weight to an initial total weight.

In some embodiments of the system, the I/O circuitry is further configured to receive a second total weight from the weight sensor. The second total weight includes the weight of the cryogenic storage container and a second weight of the content contained in the cryogenic storage container. The second total weight is captured a time interval after capture of the first total weight. The storage condition monitor circuitry is configured to determine a current rate of change of weight and to compare the current rate of change of weight to a rate of change threshold.

In some embodiments of the system, the current storage condition corresponds to a severity of coolant loss from the cryogenic storage container and is related to an amount of time available for remediation.

In some embodiments of the system, the current storage condition is selected from the group including a current total weight less than or equal to a minimum weight threshold, a current total weight greater than the minimum weight threshold and less than or equal to an intermediate weight threshold, a current weight fraction less than or equal to a minimum weight fraction threshold, a current weight fraction greater than the minimum weight fraction threshold and less than or equal to an intermediate weight fraction threshold, a current rate of change of total weight greater than or equal to a minimum rate of change threshold and less than an intermediate rate of change threshold, a current rate of change of total weight greater than or equal to the intermediate rate of change threshold and less than a maximum rate of change threshold, a current rate of change of total weight greater than or equal to the maximum rate of change threshold, and/or a combination thereof.

In some embodiments of the system, the supervisor device includes a storage facility profile store configured to store current and historical storage condition data associated with each cryogenic storage container associated with a storage facility identifier.

In some embodiments of the system, the storage condition monitor circuitry is further configured to determine the current storage condition based, at least in part, on a temperature. In some embodiments of the system, the supervisor device includes notification monitoring circuitry configured to provide a selected storage condition status indicator to a selected client device in response to a query. The query includes a cryogenic storage container identifier.

In an embodiment, there is provided a method for monitoring a storage condition in a cryogenic storage container. The method includes sensing, by a weight sensor, a first total weight of a cryogenic storage container. The weight sensor is in mechanical communication with the cryogenic storage container. The cryogenic storage container is configured to contain a coolant and a biological material storage subcontainer. The first total weight includes a weight of the cryogenic storage container and a first weight of a content contained in the cryogenic storage container. The method further includes receiving, by an input/output (I/O) circuitry, the first total weight from the weight sensor. The method further includes determining, by a storage condition monitor circuitry, a current storage condition of the cryogenic storage container based, at least in part, on the first total weight. The method further includes selecting, by the storage condition monitor circuitry, a storage condition status indicator based, at least in part, on the current storage condition. The method further includes providing, by the storage condition monitor circuitry, the storage condition status indicator to one or more of the user interface, a worker device and a supervisor device. The user interface is configured to provide at least one of a visual indicator, an audible indicator and/or an electronic indicator.

In some embodiments of the method, the determining the current storage condition includes at least one of comparing the first total weight to a weight threshold or comparing a current weight fraction to a weight fraction threshold, the current weight fraction corresponding to a ratio of the first total weight to an initial total weight.

In some embodiments, the method further includes sensing, by the weight sensor, a second total weight of the cryogenic storage container. The second total weight includes the weight of the cryogenic storage container and a second weight of the content contained in the cryogenic storage container. The second total weight is captured a time interval after capture of the first total weight. The method further includes receiving, by the I/O circuitry, the second total weight from the weight sensor. The method further includes determining, by the storage condition monitor circuitry, a current rate of change of weight. The method further includes comparing, by the storage condition monitor circuitry, the current rate of change of weight to a rate of change threshold.

In some embodiments of the method, the current storage condition corresponds to a severity of coolant loss from the cryogenic storage container and is related to an amount of time available for remediation.

In some embodiments of the method, the current storage condition is selected from the group including a current total weight less than or equal to a minimum weight threshold, a current total weight greater than the minimum weight threshold and less than or equal to an intermediate weight threshold, a current weight fraction less than or equal to a minimum weight fraction threshold, a current weight fraction greater than the minimum weight fraction threshold and less than or equal to an intermediate weight fraction threshold, a current rate of change of total weight greater than or equal to a minimum rate of change threshold and less than an intermediate rate of change threshold, a current rate of change of total weight greater than or equal to the intermediate rate of change threshold and less than a maximum rate of change threshold, a current rate of change of total weight greater than or equal to the maximum rate of change threshold, and/or a combination thereof.

In some embodiments, the method further includes providing, by a notification monitoring circuitry, a selected storage condition status indicator to a selected client device in response to a query, the query including a cryogenic storage container identifier.

In an embodiment, there is provided a computer readable storage device. The device has stored thereon instructions that when executed by one or more processors result in the following operations including any embodiment of the method.

### BRIEF DESCRIPTION OF THE DRAWINGS

FIG. 1 illustrates a cryogenic container storage condition monitoring system, according to several embodiments of the present disclosure;

FIG. 2 is an example flowchart of cryogenic container storage condition monitoring operations, according to various embodiments of the present disclosure;

FIG. 3A is a plot illustrating a weight fraction (percentage) and temperature of a cryogenic storage container for a slow rate coolant loss trial;

FIG. 3B is a plot illustrating a weight fraction (percentage) and temperature corresponding to an expansion of a portion of the plot of FIG. 3A;

FIG. 4A is a plot illustrating a weight fraction percentage and temperature of a cryogenic storage container for a medium rate coolant loss trial:

FIG. 4B is a plot illustrating a weight fraction percentage and temperature of a cryogenic storage container for another medium rate coolant loss trial;

FIG. 5A is a plot illustrating a weight fraction percentage and temperature of a cryogenic storage container for a rapid rate coolant loss trial; and

FIG. 5B is a plot illustrating a weight fraction percentage and temperature of a cryogenic storage container for another rapid rate coolant loss trial.

### DETAILED DESCRIPTION

Occurrence of unintentional thaws of cryopreserved tissues may be related to a rate of coolant loss from a cryogenic storage container. In one nonlimiting example, the rate of coolant loss may characterized as slow (i.e., low), medium (i.e., moderate) or fast (i.e., high). For example, a low rate loss may correspond to a case of “tank abandonment” where the cryopreservation tank functions normally and the coolant evaporates at an expected rate, but the tank is not refilled in a timely manner, allowing the coolant to be depleted and the temperature in the tank to rise. In another example, a moderate rate loss may correspond to a breach to the insulation of the tank, due to either damage to a vacuum seal or failure to replace the tank's foam insulation, leading to a faster than normal rate of coolant evaporation and the coolant supply being depleted prior to a next scheduled refilling. In another example, a high rate loss may correspond to a catastrophic tank failure that results in a direct leakage of coolant at a relatively high rate. As used herein, the terms “cryogenic storage container”, “cryopreservation tank” and “tank” are used interchangeably.

Generally, an apparatus, system and/or method is configured to monitor a storage condition of a cryogenic storage container and to provide a notification based, at least in part, on the storage condition. In some embodiments, the storage condition is related to a total weight of the cryogenic storage container. The total weight of the cryogenic storage container includes a weight of the cryogenic storage container itself and a weight of the contents contained in the cryogenic storage container. The contents may include a coolant and may further include one or more biological material subcontainers. Each biological material subcontainer may be configured to contain a biological material (e.g., human tissue, oocytes, embryos, gametes, sperm, etc.). The storage condition may be determined based, at least in part, on one or more of a current total weight of the cryogenic storage container, a current total weight fraction of the cryogenic storage container, a current rate of change of total weight of the cryogenic storage container and/or a combination thereof. The coolant may include, but is not limited to, liquid nitrogen (one example of a cryogenic liquefied gas), dry ice (i.e., a solid form of carbon dioxide), another cryogenic gas (i.e., another cryogenic liquefied gas, e.g., helium, hydrogen, argon, oxygen, nitrous oxide, etc.), a liquid, a solid or a combination thereof.

In some embodiments, the storage condition may be temperature-based. In these embodiments, the storage condition may be related to one or more of temperature, change in temperature and rate of change of temperature. A temperature sensor may be configured to monitor a temperature of the contents of the cryogenic storage container, the coolant, an environment surrounding the storage container, or combinations thereof. In some embodiments, the storage condition may be related to a volume of coolant within the storage container. In some embodiments, the storage condition may be related to a pressure of coolant within the storage container. In some embodiments, one or more of the weight, temperature, volume, and pressure may be monitored as redundant measures to confirm adequate storage conditions within the tank.

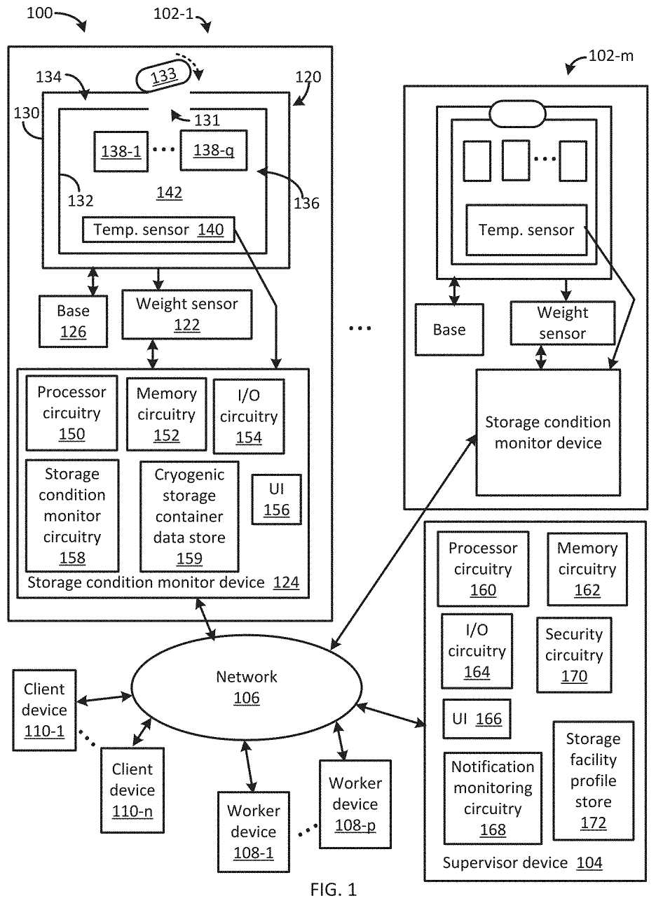

FIG. 1 illustrates a cryogenic container storage condition monitoring system 100, according to several embodiments of the present disclosure. Storage condition monitoring system 100 includes one or more storage container subsystems 102-1, . . . , 102-m, a supervisor device 104, a network 106, one or more worker devices 108-1, . . . , 108-p, and one or more client devices 110-1, . . . , 110-n. The supervisor device 104 may be coupled to each storage container subsystem 102-1, . . . , 102-m, one or more worker devices 108-1, . . . , 108-p, and/or one or more client devices 110-1, . . . , 110-n, wired and/or wirelessly, via network 106.

Each storage container subsystem, e.g., storage container subsystem 102-1, includes a cryogenic storage container 120, a weight sensor 122 and a storage condition monitor device 124. The storage container subsystem 102-1 may include a temperature sensor 140. Storage container subsystem 102-1 may further include a base 126 configured to provide mechanical support to the cryogenic storage container 120. The cryogenic storage container 120 may be positioned in or on the base 126. The base 126 may include features configured to stabilize the cryogenic storage container 120. The base 126 may include wheels and is configured to facilitate moving the cryogenic storage container 120. In one nonlimiting example, the base 126 may correspond to a dolly.

The cryogenic storage container 120 includes an outer wall 130 and an inner wall 132. In one nonlimiting example, the outer wall 130 and the inner wall 132 may be generally cylindrically shaped. However, this disclosure is not limited in this regard. The outer wall 130 is configured to enclose the inner wall 132, defining a vacuum chamber 134 between the outer wall 130 and the inner wall 132. The inner wall 132 may enclose a coolant chamber 136 configured to contain a coolant 142 and one or more biological material storage subcontainers 138-1, . . . , 138-q. The temperature sensor 140 may be positioned within the coolant chamber 136.

The outer wall 130 and the inner wall 132 may define an opening 131 configured to allow access to the contents of the cryogenic storage container 120. The cryogenic storage container 120 may further include a cover 133 configured to seal the opening 131. The cover 133 may include a feature configured to allow access to the vacuum chamber 134 for evacuating the vacuum chamber 134 to create a vacuum. The cover 133 may further include a feature configured to allow access to the coolant chamber 136 for providing coolant to the coolant chamber 136.

The weight sensor 122 is positioned in mechanical communication with the cryogenic storage container 120. For example, the weight sensor 122 may be positioned in or on the base 126. In another example, the base 126 may be positioned on the weight sensor 122. Weight sensor 122 may include, but is not limited to, a weight sensing scale, a force sensor, a load cell, a strain gauge, etc. The weight sensor 122 is configured to detect a total weight of the cryogenic storage container 120, including contents of the cryogenic storage container 120. Contents of the cryogenic storage container 120 may include the coolant 142 and one or more biological material storage subcontainers 138-1, . . . , 138-q and their respective biological materials contained therein.

The weight sensor 122 may be integrated with and/or coupled wired and/or wirelessly to the storage condition monitor device 124. The weight sensor 122 is configured to provide the detected total weight to the storage condition monitor device 124. The weight sensor 122 may be configured to provide the detected total weight continuously, intermittently, e.g., at a defined time interval, and/or in response to a request from the storage condition monitor device 124.

The storage condition monitor device 124 includes processor circuitry 150, memory circuitry 152, input/output (I/O) circuitry 154, user interface (UI) 156, a storage condition monitor circuitry 158 and a cryogenic storage container data store. Storage condition monitor device 124 may be coupled to weight sensor 122 and/or temperature sensor 140. Storage condition monitor device 124 may be further coupled, wired and/or wirelessly, to network 106. UI 156 may include an input device (e.g., keyboard, keypad, mouse, touch sensitive display, etc.) and/or an output device (e.g., a display, a sound speaker, a buzzer, a light, etc.). UI 156 may be utilized to receive user, e.g., worker, input and to provide an output, e.g., an alarm indicator, to a worker.

The cryogenic storage container data store 159 may be configured to store one or more of a cryogenic storage container identifier (ID), an initial weight (e.g., following a prior filling of the cryogenic storage container and/or upon an input from a worker via UI 156 indicating cryogenic storage container fill), a target temperature, one or more thresholds, etc. For example, the cryogenic storage container ID may be numeric, alphanumeric or text. However, this disclosure is not limited in this regard.

Storage condition monitor device 124 is configured to determine a storage condition of cryogenic storage container 120. In an embodiment, the storage condition may be determined based, at least in part, on a total weight of the cryogenic storage container 120 and its corresponding contents. The total weight of the cryogenic storage container 120 may be received from weight sensor 122 by I/O circuitry 154 and stored in memory circuitry 152. An initial weight may be received from weight sensor 122 and stored in the cryogenic storage container data store 159. The total weight of the cryogenic storage container 120 may then be utilized by the storage condition monitor circuitry 158 to determine a storage condition of the cryogenic storage container 120. The storage condition may be determined based, at least in part, on one or more of a total weight, a total weight fraction, a rate of change of total weight, an average total weight, an average total weight fraction, an average rate of change of total weight, and/or a combination thereof. An average may be determined over a time interval or a number of samples. In some embodiments, the storage condition may be further determined based, at least in part, on a coolant chamber temperature. Total weight fraction corresponds to a ratio of a current total weight to an initial total weight. Rate of change of total weight corresponds to a change of total weight over a time interval. The storage condition is related to an amount of coolant contained in the coolant chamber 142, a rate of coolant loss from the coolant chamber 142 and/or a combination thereof.

It may be appreciated that the amount of coolant and/or the rate of coolant loss may be utilized to anticipate when a temperature within the cryogenic storage container may begin to rise. The amount of coolant and/or the rate of coolant loss may indicate tank abandonment, breach of the insulation of the tank or catastrophic tank failure. In other words, based, at least in part, on the storage condition, remediation may be initiated prior to a temperature rise within the cryogenic storage container. Whether the remediation should be initiated without delay or within a more sedate time period may be determined based, at least in part, on the specific storage condition.

Storage conditions may include, but are not limited to, a current total weight less than or equal to a minimum weight threshold, a current total weight greater than the minimum weight threshold and less than or equal to an intermediate weight threshold, a current weight fraction less than or equal to a minimum weight fraction threshold, a current weight fraction greater than the minimum weight fraction threshold and less than or equal to an intermediate weight fraction threshold, a current rate of change of total weight greater than or equal to a minimum rate of change threshold and less than an intermediate rate of change threshold, a current rate of change of total weight greater than or equal to the intermediate rate of change threshold and less than a maximum rate of change threshold, a current rate of change of total weight greater than or equal to the maximum rate of change threshold, and/or a combination thereof.

In some embodiments, storage conditions may include a current temperature greater than a maximum temperature threshold, the current temperature less than the maximum temperature threshold but greater than an intermediate temperature threshold, a current average temperature greater than or equal to a maximum average temperature threshold and a current rate of change of temperature greater than a maximum rate of temperature change threshold. The current storage temperature may be detected by, e.g., temperature sensor 140, and captured by storage condition monitor device 124.

In an embodiment, storage condition monitor circuitry 158 may be configured to determine a current storage condition of the cryogenic storage container 120 based, at least in part, on a total weight received from weight sensor 122. In this embodiment, storage conditions may include a current total weight less than or equal to a minimum weight threshold, a current total weight greater than the minimum weight threshold and less than or equal to an intermediate weight threshold, a current weight fraction less than or equal to a minimum weight fraction threshold and/or a current weight fraction greater than the minimum weight fraction threshold and less than or equal to an intermediate weight fraction threshold.

In an embodiment, storage condition monitor circuitry 158 may be configured to determine a current storage condition of the cryogenic storage container 120 based, at least in part, on a first total weight and a second total weight received from weight sensor 122. The second total weight may be captured an amount of time corresponding to a sample time interval (i.e., sample period) after the first total weight was captured. In this embodiment, storage conditions may include a current rate of change of total weight greater than or equal to a minimum rate of change threshold and less than an intermediate rate of change threshold, a current rate of change of total weight greater than or equal to the intermediate rate of change threshold and less than a maximum rate of change threshold and/or a current rate of change of total weight greater than or equal to the maximum rate of change threshold.

In an embodiment, storage condition monitor circuitry 158 may be configured to determine a current storage condition of the cryogenic storage container 120 based, at least in part, on an average of a total weight received from weight sensor 122. In this embodiment, storage conditions may include an average total weight less than or equal to a minimum average weight threshold, an average total weight greater than the minimum average weight threshold and less than or equal to an intermediate average weight threshold, an average weight fraction less than or equal to a minimum average weight fraction threshold and/or an average weight fraction greater than the minimum average weight fraction threshold and less than or equal to an intermediate average weight fraction threshold.

In an embodiment, storage condition monitor circuitry 158 may be configured to determine a current storage condition of the cryogenic storage container 120 based, at least in part, on a first average total weight and a second average total weight received from weight sensor 122. The second average total weight may be captured an amount of time after the first total weight was captured. In this embodiment, storage conditions may include an average rate of change of total weight greater than or equal to a minimum average rate of change threshold and less than an intermediate average rate of change threshold, an average rate of change of total weight greater than or equal to the intermediate average rate of change threshold and less than a maximum average rate of change threshold and/or an average rate of change of total weight greater than or equal to the maximum average rate of change threshold.

In an embodiment, storage condition monitor circuitry 158 may be configured to determine a current storage condition of the cryogenic storage container 120 based, at least in part, on a first temperature and/or a second temperature received from temperature sensor 140. In this embodiment, storage conditions may include current temperature greater than a maximum temperature threshold, current temperature less than the maximum temperature threshold but greater than an intermediate temperature threshold, a current rate of change of temperature greater than or equal to a maximum rate of change of temperature, a current average temperature greater than or equal to an average temperature threshold, etc.

The storage condition monitor circuitry 158 may be configured to select a storage condition status indicator based, at least in part, on the determined storage condition. The storage condition monitor circuitry 158 may be configured to provide the selected storage condition status indicator to the supervisor device 104. The current storage condition and corresponding storage condition status indicator may correspond to a severity of coolant loss. In one nonlimiting example, the current storage condition may be related to an amount of time available for remediation before the temperature in the coolant chamber begins to rise. In another nonlimiting example, the current storage condition may be related to a change (e.g., rise) in temperature. In some embodiments, storage condition monitor circuitry 158 may be configured to communicate the storage condition status via UI 156 and/or one or more worker device(s) 108-1, . . . , 108-p. In one nonlimiting example, such “direct” communication may be performed in response to a storage condition status corresponding to a high rate of coolant loss (e.g., rate of change of total weight greater than or equal to the maximum rate of change threshold and/or a current weight below the minimum weight threshold). In one nonlimiting example, the storage condition status indicator may correspond to a coolant loss quantifier. The coolant loss quantifier may include minor loss, moderate loss and major loss. However, this disclosure is not limited in this regard and more than three or fewer than three coolant loss quantifiers may be implemented.

In another nonlimiting example, the storage condition status indicator may correspond to a current temperature greater than a temperature threshold and/or a current temperature increase (i.e., rate of change) greater than a temperature rate of change threshold.

Thus, a storage condition status indicator may be related to a weight, a temperature, and/or a combination thereof.

Supervisor device 104 includes processor circuitry 160, memory circuitry 162, I/O circuitry 164, UI 166 and notification monitoring circuitry 168. UI 166 may include an input device (e.g., keyboard, keypad, mouse, touch sensitive display, etc.) and/or an output device (e.g., a display, a sound speaker, a buzzer, a light, etc.). UI 166 may be utilized to receive user, e.g., supervisor/worker, input and to provide an output, e.g., a status indicator, to a supervisor/worker.

In some embodiments, supervisor device 104 may include security circuitry 170. Supervisor device 104 may further include a storage facility profile store 172. The storage facility profile store 172 may be configured to contain a storage facility identifier associated with one or more cryogenic storage container identifiers, one or more container subsystem identifiers, one or more parameters associated with each container subsystem (e.g., type of cryogenic storage container, age of the cryogenic storage container, a cryogenic storage container manufacturer identifier, initial fill weight, coolant type, a coolant loss history, etc.).

Supervisor device 104 is configured to receive a storage condition status indicator from each cryogenic storage container subsystem 102-1, . . . , 102-m. In some embodiments, the corresponding storage condition monitor device, e.g., storage condition monitor device 124, may be configured to provide a storage container subsystem identifier with the storage condition indicator, to the supervisor device 104. The supervisor device 104 may thus be configured to identify a cryogenic storage container that corresponds to the storage condition status indicator. For example, the storage condition status indicator may correspond to a weight, a temperature and/or a combination thereof.

Notification monitoring circuitry 168 may be configured to notify a selected worker, a subset of workers or all of the workers based, at least in part, on a severity of the corresponding storage condition. Notification may be via a corresponding worker device 108-1, . . . , and/or 108-p. The notification may include an indication of an appropriate response time by the worker(s). The appropriate response time may be related to the determined storage condition. In some embodiments, notification monitoring circuitry 168 may be further configured to notify a selected client via a corresponding client device, e.g., client device 110-1. The selected client may be identified based, at least in part, on a client identifier included in storage facility profile store 172 and associated with a biological material storage subcontainer contained in the cryogenic storage container corresponding to the received storage condition indicator.

Security circuitry 170 may be configured to receive storage condition status queries from a client via a corresponding client device, e.g., client device 110-1. Security circuitry 170 is configured to maintain security (e.g., anonymity) of other clients when receiving and responding to storage conditions status queries from an individual client. In other words, each cryogenic storage container, e.g., cryogenic storage container 120, may contain biological materials from more than one client. Security circuitry 170 is configured to prevent each client from learning the identities of any other clients.

Notification monitor circuitry 168 is configured to respond to a storage condition status query. Storage condition status queries and corresponding responses may include a current storage condition of the cryogenic storage container that contains the clients biological material, a history of storage conditions over a defined time interval, a history of remediation activities, etc. The current storage condition may be related to weight and/or temperature of the cryogenic storage container and contents. Current storage condition status indicator may thus correspond to a weight, a temperature, a change in weight and/or a change in temperature.

In some embodiments, the UI 156 may include a visual indicator, auditory indicator and/or an electronic indicator of storage container status. The electronic indicator may include, but is not limited to, an email, a text message, a telephone message, etc. By way of example, in some embodiments, UI 156 may include a multicolor indicator. When the indicator is green, the storage conditions are acceptable to maintain the stored material. When the indicator is yellow, the storage conditions should be monitored as they are deviating or beginning to deviate from an acceptable baseline. When the indicator is red, the storage conditions may be adversely affecting the material being stored and should be corrected. In some embodiments, the visual indicator displays the current temperature and/or weight and/or additional parameter of the cryogenic storage container relative to a predefined “normal” range.

In some embodiments, notification circuitry 168 may be configured to receive queries from one or more client devices. In one nonlimiting example, a client device, e.g., client device 110-1, may correspond to a smartphone or a tablet computer. The query may include a cryogenic storage container ID. Notification circuitry 168 may be configured to determine a current value of, e.g., temperature and/or weight, of the identified cryogenic storage container in response to the query. Notification circuitry 168 may be further configured to provide the current value to the client device. For example, the query may correspond to a request for a current temperature of the contents of the cryogenic storage container. Such operations may correspond to a PreBaby Monitor.

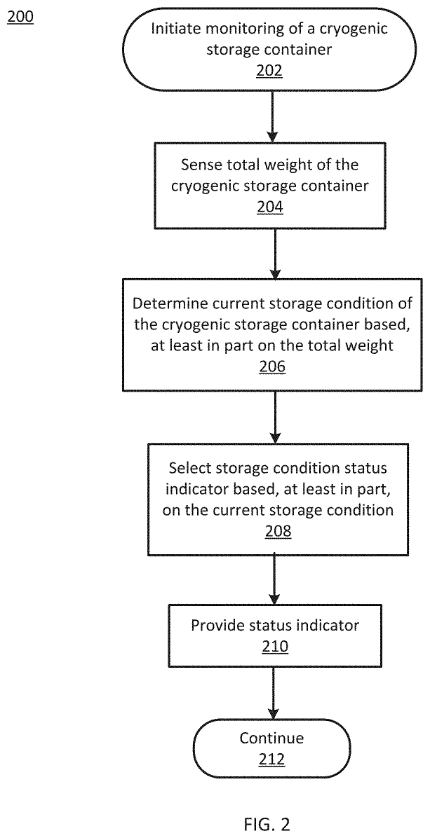

FIG. 2 is a flowchart 200 of cryogenic container storage condition monitoring operations according to various embodiments of the present disclosure. In particular, the flowchart 200 illustrates determining a storage condition of a cryogenic storage container. The operations may be performed, for example, by a storage container subsystem, e.g., storage container subsystem 102-1 and storage condition monitor device 124 of FIG. 1.

Operations of this embodiment may begin following the cryogenic storage container being filled with coolant and allowed to come to equilibrium. Operations of this embodiment may begin with initiating monitoring of a cryogenic storage container at operation 202. Operation 204 includes sensing a total weight of the cryogenic storage container. A current storage condition of the cryogenic storage container may be determined based, at least in part, on the total weight at operation 206. A storage condition status indicator may be selected based, at least in part, on the current storage condition at operation 208. The status indicator may be provided at operation 201. Program flow may then continue at operation 212.

Thus, a condition of a cryogenic container storage condition may be monitored based, at least in part, on a current total weight and a storage condition status indicator may be provided.

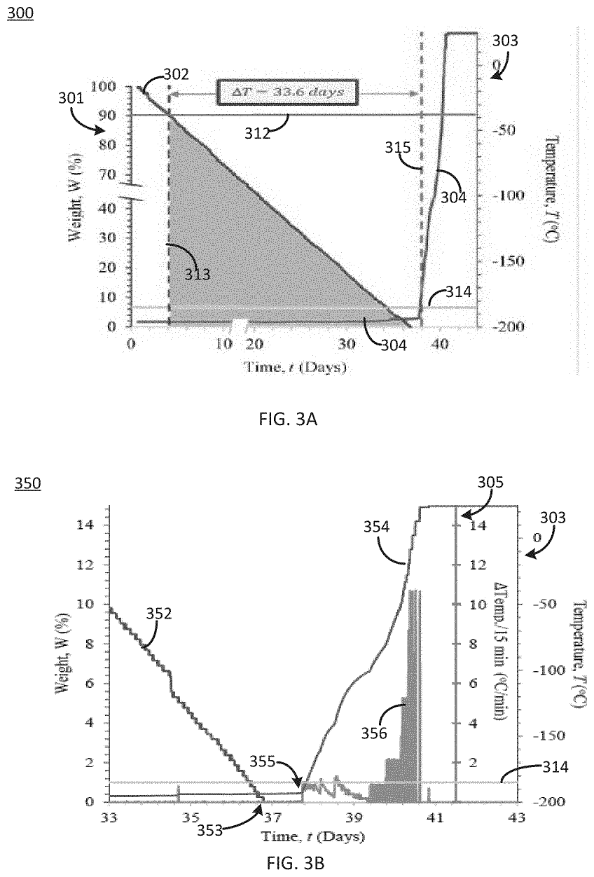

FIGS. 3A, 3B, 4A, 4B, 5A, and 5B are plots generated from experimental data captured for two example cryogenic storage tanks with simulated coolant loss profiles. Table 1 includes time interval durations for coolant loss/temperature rise trials, described herein. All experiments were performed with a same type of cryogenic storage tank containing empty biological material subcontainers. Tanks were placed on the scales and the scales were tared. The tanks were then filled with LN2, and topped-off until temperature reached equilibrium and LN2 boiling ceased. Temperature within the tanks was simultaneously monitored with probes placed near the top of the tanks with a −185° C. threshold temperature. Ambient room temperatures were 23-25° C.

The coolant loss rates were configured to correspond to low, moderate and high loss rates, as described herein. Experimental data included measurements of total weight and coolant temperature (i.e., temperature within a cryogenic storage container) over time, as well as a change of temperature over a predefined time interval (e.g., 15 minutes). Weights were continuously monitored and recorded, with a calculated weight fraction threshold trigger set at 10% weight loss. For the “slow rate-loss” simulations, tanks were left intact and closed in usual operating conditions, and LN2 was allowed to evaporate at the normal rate. For the “medium rate-loss” simulation, the foam core of the tank neck was removed and the insulating vacuum was eliminated by making a 1/16 inch hole in the outer tank wall. For the “fast rate-loss” simulation, a 1/16″ hole was made through the outer tank wall and LN2 was released at a rate of 0.15 L/second. All simulations were performed in duplicate.

Generally, with an intact and normally functioning tank, a 10% loss in LN2 occurred in 4.2-4.9 days. Warming to −185° C. occurred in 37.8-43.7 days, over 30 days after the weight fraction threshold was reached. Full evaporation of LN2 took 36.8 days. For the medium rate-loss simulation, a 10% loss in LN2 occurred in 0.8 h. Warming to −185° C. occurred in 3.7-4.8 hours, approximately 3 hours after the weight fraction threshold was reached. For the fast rate-loss simulation, a 10% weight loss occurred within 15 seconds and tanks were completely depleted in under 3 minutes. Tank temperatures began to rise immediately and at a relatively constant rate of 43.9° C./hour and 51.6° C./hour. Temperature alarms (corresponding to the temperature threshold) would have sounded within 0.37 and 0.06 hours after the breech.

Thus, a weight-based cryogenic storage tank monitoring system can detect tank failures prior to a temperature-based monitoring system, in some cases over a month in advance. A weight-based monitoring system could serve as a safety mechanism for added protection of cryopreserved reproductive tissues.

TABLE 1

| | Slow | Slow | Medium | Medium | Fast | Fast |
|---|---|---|---|---|---|---|
| | rate | rate | rate | rate | rate | rate |
| | Tank A | Tank B | Run 1 | Run 2 | Run 1 | Run 2 |
| | (days) | (days) | (hours) | (hours) | (hours) | (hours) |
| Time to | 4.2 | 4.9 | 0.8 | 0.8 | N/A | NA |
| 10% decr. | | | | | | |
| Time to | 37.8 | 43.7 | 3.7 | 4.8 | 0.37 | 0.06 |
| −185° C. | | | | | | |
| Δ Time | 33.7 | 38.8 | 3.0 | 4.0 | N/A | N/A |

For the slow rate-loss simulation, designed to mimic what would occur if a fully functioning tank was left unattended, two LN2 dewars (Tank A and Tank B) were filled to capacity with LN2, topped-off until temperature reached equilibrium and LN2 boiling ceased, and then left undisturbed while the tank weights and temperatures were monitored continuously. The time for a 10% loss in LN2 was 4.2 and 4.9 days for Tanks A and B, respectively. Warming to −185° C. occurred in 37.8 and 43.7 days for Tanks A and B, respectively. Thus, the weight-based system was able to detect a 10% weight loss between 33.7 and 38.8 days before the temperature alarm threshold was reached. The rate of LN2 loss was 1.05 kg/day and 0.89 kg/day for Tank A and B, respectively.

For the medium rate-loss simulation, designed to mimic what would occur if the insulating capacity of a tank were compromised, the tank's vacuum seal was breached and insulating foam in the tank neck was removed. Dewars were then filled to capacity with LN2, topped-off until temperature reached equilibrium and LN2 boiling ceased and then left alone while the tank weight and temperature was monitored continuously. The time for a 10% loss in LN2 was 0.8 hours for runs 1 and 2. Warming to −185° C. occurred in 3.7 and 4.8 hours for runs 1 and 2, respectively (Table 1). Thus, the weight-based system was able to detect a 10% weight loss between 3.0 and 4.0 hours before the temperature alarm threshold was reached.

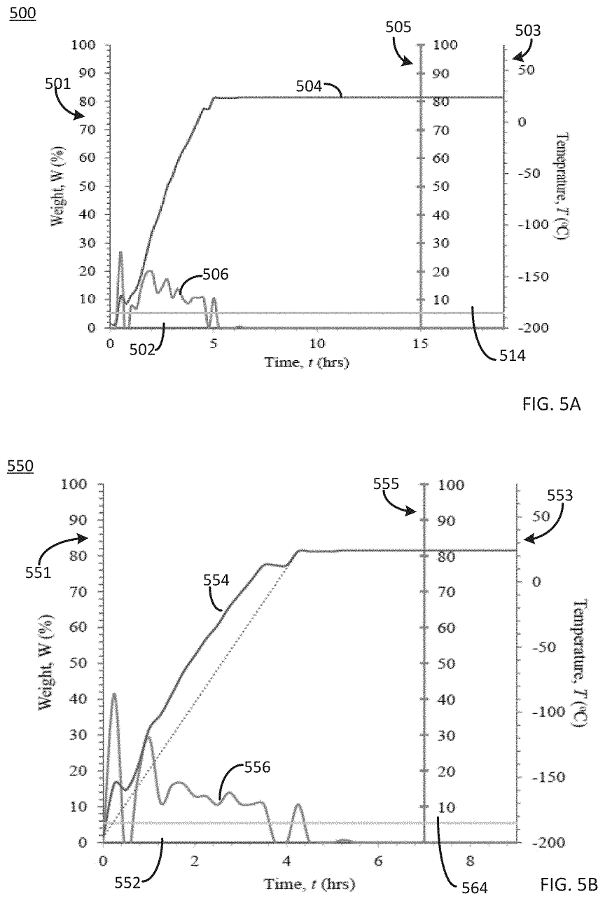

For the fast rate-loss simulation, designed to mimic what would occur if a catastrophic tank breech were to cause LN2 to rapidly spill from the cryogenic storage container, the tanks' vacuum seal was breached. The tanks were then filled to capacity with LN2, topped-off until the temperature reached equilibrium and LN2 boiling ceased. The LN2 was then evacuated at a rate of 0.15 L/second until empty. The tanks were left alone while their temperature and weight were monitored. Thus, a 10% weight loss occurred within 15 seconds and tanks were completely depleted in under 3 minutes. As shown in FIGS. 5A and 5B (shown below), tank temperatures began to rise immediately and at a relatively constant rate of 43.9° C./hour and 51.6° C./hour. Temperature threshold triggered within 0.37 and 0.06 hours after the breech.

FIG. 3A is a plot 300 illustrating a weight fraction (percentage) 302 and temperature 304 of a cryogenic storage container for a slow rate coolant loss trial. In this trial, the coolant was liquid nitrogen (LN2). A left hand vertical axis 301 corresponds to weight fraction (ratio of current total weight to initial total weight of a cryogenic storage container and contents including coolant) percentage (%). A horizontal axis corresponds to time with units of days. A right hand vertical axis 303 corresponds to temperature in units of degrees Celsius (° C.) in a coolant chamber of the cryogenic storage container. Plot 300 further includes one example intermediate weight fraction threshold 312 of 90%. However, this disclosure is not limited in this regard. Plot 300 further includes one example temperature threshold 314 of −185° C. However, this disclosure is not limited in this regard.

In this example, an interval between the weight fraction percentage decreasing 10% from 100% to 90% and a rise in temperature from an initial temperature of −200° C. to −185° C. is 33.6 days and is indicated as an interval between dashed lines 313 and 315. Full evaporation occurred at 36.8 days. It may be appreciated that a rate of weight loss can be described as a line as W=−2.778t+101.48, where W is the coolant weight (as a percentage of total) and t is time (measured in days; R²=0.9999).

FIG. 3B is a plot 350 illustrating a weight fraction (percentage) 352 and temperature 354 corresponding to an expansion of a portion of plot 300 of FIG. 3A. The expansion corresponds to a period of time between days 33 and 43 and includes a time interval between a first point in time 353 when the cryogenic storage container is empty of coolant and a second point in time when the temperatures begin to rise 355. A third vertical axis 305 corresponds to temperature change over 15 minute time intervals in units of degrees Celsius (° C.) per minute (min) in a coolant chamber of the cryogenic storage container. Plot 350 further includes a rate of temperature increase 356 illustrated as a change in temperature (° C.) over a 15 min interval. Tank temperatures, as recorded by a temperature probe placed a few centimeters below the tank neck, remained stable until LN2 was at or nearly completely depleted. Thereafter, the rate of warming was nearly constant and occurred at a rate of and 60.5° C./day.

Thus, at the low rate of coolant loss, there was a delay between complete loss of coolant and detecting a temperature increase. It is hypothesized that the status of the cryogenic storage container corresponding to the coolant loss rate affects the insulating characteristics of the container and thus the rate of change of the temperature.

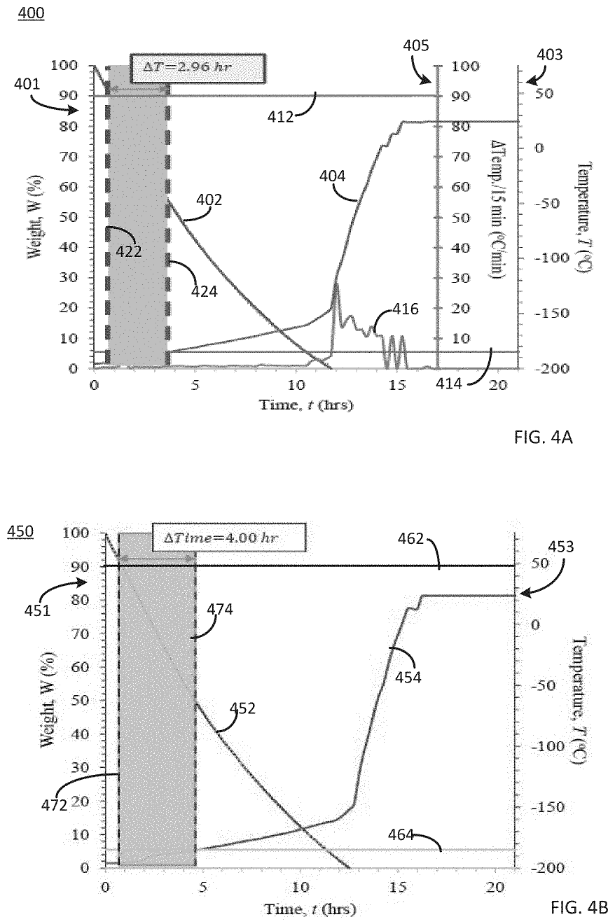

FIG. 4A is a plot 400 illustrating a weight fraction (percentage) 402 and temperature 404 versus time of a cryogenic storage container for a medium rate coolant loss trial. In this trial, the coolant was liquid nitrogen (LN2). A left hand vertical axis 401 corresponds to weight fraction percentage (%). A horizontal axis corresponds to time with units of hours. A first right hand vertical axis 403 corresponds to temperature in units of ° C. in a coolant chamber of the cryogenic storage container. A second right hand vertical axis 405 corresponds to temperature change over 15 minute time intervals in units of ° C. per minute (min) in a coolant chamber of the cryogenic storage container. Plot 400 further includes one example intermediate weight fraction threshold 412 of 90%. However, this disclosure is not limited in this regard. Plot 400 further includes one example temperature threshold 414 of −185° C. However, this disclosure is not limited in this regard.

In this example, an interval between the weight fraction percentage decreasing 10% from 100% to 90% and a rise in temperature from an initial temperature of −200° C. to −185° C. is approximately 2.96 hours and is indicated as an interval between dashed lines 422 and 424. It may be appreciated that a rate of weight loss can be described as W=0.4447t²−13.661t+100.07 (where W represents weight, measured as a percentage of total and t represents time, measured in hours; R²=0.9997). The rate of change of temperature, measured in 15 minute intervals and recorded as ° C./min is shown in curve 416.

FIG. 4B is a plot 450 illustrating a weight fraction (percentage) 452 and temperature 454 versus time of a cryogenic storage container for another medium rate coolant loss trial. In this trial, the coolant was liquid nitrogen (LN2). A left hand vertical axis 451 corresponds to weight fraction percentage (%). A horizontal axis corresponds to time with units of hours. A right hand vertical axis 453 corresponds to temperature in units of ° C. in a coolant chamber of the cryogenic storage container. Plot 450 further includes one example intermediate weight fraction threshold 462 of 90%. However, this disclosure is not limited in this regard. Plot 450 further includes one example temperature threshold 464 of −185° C. However, this disclosure is not limited in this regard.

In this example, an interval between the weight fraction percentage decreasing 10% from 100% to 90% and a rise in temperature from an initial temperature of −200° C. to −185° C. is approximately 4 hours and is indicated as an interval between dashed lines 472 and 474. It may be appreciated that a rate of weight loss can be described as W=0.3565t²−12.383t+100.09 (where W represents weight, measured as a percentage of total and t represents time, measured in hours; R²=0.9998).

For the medium rate coolant loss experiments, the rate of LN2 loss was significantly higher compared to the low rate coolant loss and was fastest for the loss of the initial 50% of LN2. For example, the first 50% of volume was lost in 4.3 and 4.7 hours for run 1 (plot 400) and run 2 (plot 450), respectively, while the remaining 50% of tank volume and was lost in 7.5 and 7.8 hours for run 1 (plot 400) and 2 (plot 450), respectively. In contrast to the low rate coolant loss data, temperatures in the compromised tanks began rising much sooner-just about one hour after 10% of LN2 volume was lost. The rate of temperature rise was bi-phasic with a slower rate of warming (3° C./hour and 2.3° C./hour for run 1 and 2, respectively) while LN2 was present and a much faster rate of warming (48° C./hour and 58.3° C./hour for run 1 and 2, respectively) after LN2 was depleted (Plots 400 and 450).

FIG. 5A is a plot 500 illustrating a weight fraction (percentage) 502 and temperature 504 of a cryogenic storage container for a rapid rate coolant loss trial. In this trial, the coolant was liquid nitrogen (LN2). A left hand vertical axis 501 corresponds to weight fraction percentage (%). A horizontal axis corresponds to time with units of hours. A first right hand vertical axis 503 corresponds to temperature in units of ° C. in a coolant chamber of the cryogenic storage container. A second right hand vertical axis 505 corresponds to temperature change over 15 minute time intervals in units of ° C. per minute (min) in a coolant chamber of the cryogenic storage container. Plot 500 further includes one example temperature threshold 514 of −185° C. However, this disclosure is not limited in this regard.

In this example, the weight fraction percentage decreasing approximately 100% happens quickly (i.e., much less than one hour) and the weight fraction percentage is approximately zero for most of the time interval illustrated in the plot 500. A rise in temperature from an initial temperature of −200° C. to −185° C. is also relatively fast but lags the weight fraction reaching zero by less than an hour. The rate of change of temperature, measured in 15 minute intervals and recorded as ° C./min is shown in curve 506.

FIG. 5B is a plot 550 illustrating a weight fraction (percentage) 552 and temperature 554 of a cryogenic storage container for another rapid rate coolant loss trial. A left hand vertical axis 551 corresponds to weight fraction percentage (%). A horizontal axis corresponds to time with units of hours. A first right hand vertical axis 553 corresponds to temperature in units of ° C. in a coolant chamber of the cryogenic storage container. A second right hand vertical axis 555 corresponds to temperature change over 15 minute time intervals in units of ° C. per minute (min) in a coolant chamber of the cryogenic storage container. Plot 550 further includes one example temperature threshold 564 of −185° C. However, this disclosure is not limited in this regard.

In this example, the weight fraction percentage decreasing approximately 100% happens quickly (i.e., much less than one hour) and the weight fraction percentage 552 is approximately zero for most of the time interval illustrated in the plot 550. A rise in temperature from an initial temperature of −200° C. to −185° C. is also relatively fast but lags the weight fraction reaching zero by less than an hour. The rate of change of temperature, measured in 15 minute intervals and recorded as ° C./min is shown in curve 556.

Methods and system of the present disclosure are advantageous to more effectively monitor and thus maintain the storage conditions within a storage container. By relying on the weight or rate of consumption of coolant, the system is able to provide a storage condition indicator (e.g., transmit an alarm) when levels of coolant are low, but still present. Thus, there is still time to replenish the coolant before affecting the storage conditions, and the specimens are better preserved. The monitoring can be done externally to the storage container and thus does not interfere with existing alarms or with moving specimens stored within the containers. Further, the monitoring can be built into the storage container or into a wheeled base on which the tank sits, or can be a stand-alone addition. The system can be used in addition to the existing methods and thus provides a level of redundancy in protection of specimens. The embodiments of the present disclosure would be particularly advantageous for manufacturers of liquid nitrogen storage tanks, manufacturers of dollies, manufacturers of alarms for liquid nitrogen storage tanks, industrial uses of cryopreservation, i.e., seed storage, volatile liquid storage, and the like. This can be used in any scenario where monitoring of the volume of a solution is desired.

Thus, a weight-based, automated alarm system can detect tank failures prior to a temperature-based system. The time interval between the weight-based and temperature-based alarms varies depending on the threshold set for each and the rapidity and nature of the loss. Using standard temperature alarm settings and a 10% weight-loss threshold, the weight-based alarm detected anomalies as far as 33 days in advance of a temperature rise. In cases where there was a higher rate of LN2 loss, the interval was smaller.

When the insulating capacity of the tanks were left intact, temperatures remained low until several days after LN2 was completely depleted whereas, when the insulating capacity was breached, temperatures began rising much sooner. It is hypothesized that this may be because, with the insulation intact, supercooled nitrogen vapor was able to maintain low tank temperatures, but this ability failed without the vacuum layer. This is of practical implication because the normal buffer time available to replenish LN2 is drastically shortened in cases of the loss of insulating capacity.

It is contemplated that some embodiments of the present disclosure may be used in the cryopreservation of animal cell lines. Given the ability to accurately record the rate of loss of LN2, weight sensing may be used for QC testing of tanks, including new tanks, to confirm that they maintain LN2 as specified.

The experimental data was captured using a single brand and make of dewar (i.e., cryogenic storage container). There is likely variation in the rate of LN2 loss and temperature rise depending on the particular make, model and integrity of the dewar. The time interval between when weight-based and temperature-based alarms trigger also can depend on where within the tank the temperature probe is placed. For the experimental data herein, temperature probes were placed near the top of the tank. Placing the temperature probe near the bottom of the tank could result in even more LN2 lost before a temperature probe would detect a change. The threshold for triggering a temperature alarm was set at −185° C. in order to minimize the interval between the weight and temperature-based thresholds. Using a warmer temperature threshold could be expected to extend the interval between when the weight-based and temperature-based alarms would trigger and would also reduce the time available to respond before samples were lost.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry (e.g., programmable logic devices, programmable array logic, field programmable gate arrays, etc.), programmable circuitry (e.g., computer processors including one or more individual instruction processing cores, microcontrollers, etc.), state machine circuitry, and/or firmware that stores instructions executed by programmable circuitry.

The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

The foregoing provides example system architectures and methodologies, however, modifications to the present disclosure are possible. The processor circuitry 150, 160 may include one or more processor cores and may be configured to execute system software. System software may include, for example, an operating system.

Memory circuitry 152, 162 may each include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

Although the disclosure includes description illustrated with respect to exemplary embodiments thereof, it should be understood by those skilled in the art that the foregoing and various other changes, omissions and additions may be made therein and thereto, without parting from the spirit and scope of the present disclosure.

What is claimed is:

1. A storage condition monitoring device for monitoring a storage condition in a cryogenic storage container, the storage condition monitoring device comprising:
an input/output (I/O) circuitry configured to receive a first total weight from a weight sensor, the first total weight comprising a weight of the cryogenic storage container and a first weight of a content contained in the cryogenic storage container, the cryogenic storage container configured to contain a coolant and a biological material storage subcontainer;
a memory circuitry;
a processor circuitry;
a user interface configured to provide at least one of a visual indicator, an audible indicator and/or an electronic indicator; and
a storage condition monitor circuitry configured to determine a current storage condition of the cryogenic storage container based, at least in part, on the first total weight,
the storage condition monitor circuitry further configured to select a storage condition status indicator based, at least in part, on the current storage condition and to provide the storage condition status indicator to one or more of the user interface, a worker device and a supervisor device.

2. The storage condition monitoring device of claim 1, wherein the determining the current storage condition comprises at least one of comparing the first total weight to a weight threshold or comparing a current weight fraction to a weight fraction threshold, the current weight fraction corresponding to a ratio of the first total weight to an initial total weight.

3. The storage condition monitoring device of claim 1, wherein the I/O circuitry is further configured to receive a second total weight from the weight sensor, the second total weight comprising the weight of the cryogenic storage container and a second weight of the content contained in the cryogenic storage container, the second total weight captured a time interval after capture of the first total weight and the storage condition monitor circuitry is configured to determine a current rate of change of weight and to compare the current rate of change of weight to a rate of change threshold.

4. The storage condition monitoring device of claim 1, wherein the current storage condition corresponds to a severity of coolant loss from the cryogenic storage container and is related to an amount of time available for remediation.

5. The storage condition monitoring device of claim 1, wherein the current storage condition is selected from the group comprising a current total weight less than or equal to a minimum weight threshold, a current total weight greater than the minimum weight threshold and less than or equal to an intermediate weight threshold, a current weight fraction less than or equal to a minimum weight fraction threshold, a current weight fraction greater than the minimum weight fraction threshold and less than or equal to an intermediate weight fraction threshold, a current rate of change of total weight greater than or equal to a minimum rate of change threshold and less than an intermediate rate of change threshold, a current rate of change of total weight greater than or equal to the intermediate rate of change threshold and less than a maximum rate of change threshold, a current rate of change of total weight greater than or equal to the maximum rate of change threshold, and/or a combination thereof.

6. A cryogenic container storage condition monitoring system, the system comprising:
a weight sensor in mechanical communication with a cryogenic storage container, the cryogenic storage container configured to contain a coolant and a biological material storage subcontainer, the weight sensor configured to sense a first total weight of the cryogenic storage container, the first total weight comprising a weight of the cryogenic storage container and a first weight of a content contained in the cryogenic storage container;
a storage condition monitoring device comprising an input/output (I/O) circuitry configured to receive the first total weight from the weight sensor, a memory circuitry, a processor circuitry, a user interface configured to provide at least one of a visual indicator, an audible indicator and/or an electronic indicator, and a storage condition monitor circuitry; and
a supervisor circuitry coupled to the storage condition monitoring device,
the storage condition monitor circuitry configured to determine a current storage condition of the cryogenic storage container based, at least in part, on the first total weight, the storage condition monitor circuitry further configured to select a storage condition status indicator based, at least in part, on the current storage condition and to provide the storage condition status indicator to one or more of the user interface, a worker device and the supervisor device.

7. The cryogenic container storage condition monitoring system of claim 6, wherein the determining the current storage condition comprises at least one of comparing the first total weight to a weight threshold or comparing a current weight fraction to a weight fraction threshold, the current weight fraction corresponding to a ratio of the first total weight to an initial total weight.

8. The cryogenic container storage condition monitoring system of claim 6, wherein the I/O circuitry is further configured to receive a second total weight from the weight sensor, the second total weight comprising the weight of the cryogenic storage container and a second weight of the content contained in the cryogenic storage container, the second total weight captured a time interval after capture of the first total weight and the storage condition monitor circuitry is configured to determine a current rate of change of weight and to compare the current rate of change of weight to a rate of change threshold.

9. The cryogenic container storage condition monitoring system of claim 6, wherein the current storage condition corresponds to a severity of coolant loss from the cryogenic storage container and is related to an amount of time available for remediation.

10. The cryogenic container storage condition monitoring system of claim 6, wherein the current storage condition is selected from the group comprising a current total weight less than or equal to a minimum weight threshold, a current total weight greater than the minimum weight threshold and less than or equal to an intermediate weight threshold, a current weight fraction less than or equal to a minimum weight fraction threshold, a current weight fraction greater than the minimum weight fraction threshold and less than or equal to an intermediate weight fraction threshold, a current rate of change of total weight greater than or equal to a minimum rate of change threshold and less than an intermediate rate of change threshold, a current rate of change of total weight greater than or equal to the intermediate rate of change threshold and less than a maximum rate of change threshold, a current rate of change of total weight greater than or equal to the maximum rate of change threshold, and/or a combination thereof.

11. The cryogenic container storage condition monitoring system of claim 6, wherein the supervisor device comprises a storage facility profile store configured to store current and historical storage condition data associated with each cryogenic storage container associated with a storage facility identifier.

12. The cryogenic container storage condition monitoring system of claim 6, wherein the storage condition monitor circuitry is further configured to determine the current storage condition based, at least in part, on a temperature.

13. The cryogenic container storage condition monitoring system of claim 6, wherein the supervisor device comprises notification monitoring circuitry configured to provide a selected storage condition status indicator to a selected client device in response to a query, the query comprising a cryogenic storage container identifier.

14. A method for monitoring a storage condition in a cryogenic storage container, the method comprising, the method comprising:
sensing, by a weight sensor, a first total weight of a cryogenic storage container, the weight sensor in mechanical communication with the cryogenic storage container, the cryogenic storage container configured to contain a coolant and a biological material storage subcontainer, the first total weight comprising a weight of the cryogenic storage container and a first weight of a content contained in the cryogenic storage container;
receiving, by an input/output (I/O) circuitry, the first total weight from the weight sensor;
determining, by a storage condition monitor circuitry, a current storage condition of the cryogenic storage container based, at least in part, on the first total weight;
selecting, by the storage condition monitor circuitry, a storage condition status indicator based, at least in part, on the current storage condition; and
providing, by the storage condition monitor circuitry, the storage condition status indicator to one or more of the user interface, a worker device and a supervisor device, the user interface configured to provide at least one of a visual indicator, an audible indicator and/or an electronic indicator.

15. The method of claim 14, wherein the determining the current storage condition comprises at least one of comparing the first total weight to a weight threshold or comparing a current weight fraction to a weight fraction threshold, the current weight fraction corresponding to a ratio of the first total weight to an initial total weight.

16. The method of claim 14, further comprising
sensing, by the weight sensor, a second total weight of the cryogenic storage container, the second total weight comprising the weight of the cryogenic storage container and a second weight of the content contained in the cryogenic storage container, the second total weight captured a time interval after capture of the first total weight;
receiving, by the I/O circuitry, the second total weight from the weight sensor;
determining, by the storage condition monitor circuitry, a current rate of change of weight; and
comparing, by the storage condition monitor circuitry, the current rate of change of weight to a rate of change threshold.

17. The method of claim 14, wherein the current storage condition corresponds to a severity of coolant loss from the cryogenic storage container and is related to an amount of time available for remediation.

18. The method of claim 14, wherein the current storage condition is selected from the group comprising a current total weight less than or equal to a minimum weight threshold, a current total weight greater than the minimum weight threshold and less than or equal to an intermediate weight threshold, a current weight fraction less than or equal to a minimum weight fraction threshold, a current weight fraction greater than the minimum weight fraction threshold and less than or equal to an intermediate weight fraction threshold, a current rate of change of total weight greater than or equal to a minimum rate of change threshold and less than an intermediate rate of change threshold, a current rate of change of total weight greater than or equal to the intermediate rate of change threshold and less than a maximum rate of change threshold, a current rate of change of total weight greater than or equal to the maximum rate of change threshold, and/or a combination thereof.

19. The method of claim 14, further comprising providing, by a notification monitoring circuitry, a selected storage condition status indicator to a selected client device in response to a query, the query comprising a cryogenic storage container identifier.

20. A computer readable storage device having stored thereon instructions that when executed by one or more processors result in the following operations comprising: the method according to claim 14.
